(19) United States
(12) Patent Application Publication
(10) Pub. No.: US 2008/0123475 A1
(43) Pub. Date: May 29, 2008

(54) TIMEPIECE COMPONENT AND TIMEPIECE HAVING THE TIMEPIECE COMPONENT

(75) Inventors: Akihiro FUJIMORI, Suwa (JP); Masami MURAI, Shiojiri (JP); Susumu ARAI, Nagano (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 11/941,540

(22) Filed: Nov. 16, 2007

(30) Foreign Application Priority Data
Nov. 28, 2006 (JP) 2006-320655
Nov. 28, 2006 (JP) 2006-320656
Jul. 18, 2007 (JP) 2007-186784
Jul. 18, 2007 (JP) 2007-186785

(51) Int. Cl. G04B 13/00

(52) U.S. Cl. 368/322

(57) ABSTRACT

A timepiece component having a sliding friction part that slides in contact with another timepiece component, or a switching part that changes the contact state with another timepiece component in response to an operation operating the timepiece, wherein the contact surface of the sliding friction part or switching part is coated with a composite plating containing carbon nanotubes in a metal plating.

### BACKGROUND

1. Field of Invention

The present invention relates to a timepiece component and to a timepiece having the timepiece component.

2. Description of Related Art

Composite plating having fine particles mixed in a metal plating that are formed by a eutectic reaction of a metal mixed with insoluble particles in a common electroplating bath or chemical plating bath are known from the literature. Composite plating enables forming a coating with outstanding hardness, wear resistance, lubricity, and other desirable characteristics by appropriately selecting the metal plating and particle materials. See, for example, Japanese Unexamined Patent Appl. Pub. JP-A-2006-28636.

The composite plating taught in JP-A-2006-28636 can form a composite plating featuring high hardness and a smooth surface by mixing carbon nanotubes as the particles in a nickel plating as the metal plating by mixing a brightener, polyacrylic acid, and carbon nanotubes in a Watts bath of primarily nickel sulfate and nickel chloride to adjust the composite plating solution and applying an electroplating process.

Timepieces that move hands using energy from a battery or spring are also known. Such timepieces use timepiece components that have sliding friction parts that slide in contact with other timepiece parts and switching parts that change the contact state with other timepiece parts as a result of an operation adjusting the timepiece.

Special horological oils are used to impart wear resistance and lubrication to these sliding friction parts and switching parts because they tend to wear easily due to point contact with other timepiece parts.

FIG. 7 shows the results of a wear test of an electroless nickel plating using alumina spheres with and without lubrication.

This test was conducted using a reciprocating pivoted ball-on-plate friction and wear tester. The test samples had a 20 μm thick nickel plating formed by an electroless plating process on a substrate (high carbon steel, hardness Hv=700, surface roughness Ra=5 nm). Alumina spheres (Al2O3) (hardness Hv=1500) were used as the abrasive agent.

The test conditions were a load of 200 g (30 kg/mm2), a stroke of 2 Hz (0.5 Hz/stroke), a stroke length of 10 mm, and total time of 1400 seconds. These test conditions are equivalent to a two month durability test when converted to the sliding between the bottom pivot of the third pinion and the jewel of a timepiece component.

FIG. 7 shows the number of strokes on the x-axis and the coefficient of friction on the y-axis. Curve E shows the test results under these conditions when the contact surface between the sample and the abrasive agent was lubricated, and curve F shows the test results when the contact surface between the sample and the abrasive agent was not lubricated.

As shown by curve E, the coefficient of friction is stable at approximately 0.1 even as the number of strokes increases when the contact surface is lubricated.

As shown by curve F, however, when the contact surface is not lubricated, the coefficient of friction rises rapidly to approximately 0.6 between 0 and approximately 300 strokes. As the stroke count then continues to rise, the coefficient of friction increases gradually to approximately 0.6 again.

The rapid rise in the coefficient of friction to approximately 0.6 between 0 to 200 strokes is thought to be because great force is temporarily applied due to contact with other timepiece parts, and the plating at the contact surface is rough and wears. It is also thought that the subsequent increase in the coefficient of friction is due to waste produced from wear of the contact surface plating adhering to the contact surface as the number of strokes increases.

Lubrication stabilizes the coefficient of friction within the limits of the test described above, but even when such timepiece parts are lubricated using a horological oil, the oil degrades and the friction resistance increases during use over long periods of time and in low temperature environments. This leads to the problem of increased energy consumption and the timepiece even stopping. One possible solution is to realize lubrication-free timepiece components.

However, because great force is momentarily applied by point contact with other timepiece parts to these sliding friction parts and switching parts, friction resistance is increased by the contact surface wearing and becoming rough and by the waste produced by contact surface wear adhering to the contact surface. As a result, the sliding friction parts and switching parts may be coated with a plating having high hardness by heat treating an electroless nickel plating, or a lubricating plating that contains Teflon ® in an electroless nickel plating. However, because the friction resistance still becomes great over extended use as described above even when the parts are coated with this type of plating, regular disassembly, cleaning, and lubricating is essential. In other words, realizing lubrication-free timepiece parts is difficult.

In order to improve the retention of the horological oil when the parts are lubricated, an oil dispersion prevention process is applied to improve oil retention and prevent the oil from scattering and flowing by coating the sliding friction parts and switching parts with a fluoropolymer, for example. Even when such an oil dispersion prevention process is applied, however, oil retention degrades over extended use and the oil scatters and flows. Regular disassembly, cleaning, and lubrication is therefore still needed, and the oil dispersion prevention process must be reapplied in order to improve oil retention.

### SUMMARY

A timepiece part and a timepiece having the timepiece part according to the present invention (1) enable long-term use of a timepiece without lubrication by significantly improving the wear resistance and lubricity of sliding friction parts and switching parts, and (2) improve the oil retention of sliding friction parts and switching parts and enable long-term use of a timepiece without reapplying an oil dispersion prevention process.

With respect to (1), the inventors discovered a method of reducing the coefficient of friction and dramatically improving wear resistance and lubricity by coating the sliding friction parts or switching parts of a timepiece component with a composite plating containing carbon nanotubes in a metal plating, and thereby enabling using the timepiece for a long time without regular disassembly, cleaning, and lubrication.

A timepiece component according to a first aspect of the invention is a timepiece component that has a sliding friction part that slides in contact with another timepiece component, or a switching part that changes the contact state with another timepiece component in response to an operation operating the timepiece, wherein the contact surface of the sliding friction part or switching part is coated with a composite plating containing carbon nanotubes in a metal plating.

By thus coating the contact surface of the sliding friction part or switching part of a timepiece component with a composite plating containing carbon nanotubes in a metal plating, the coefficient of friction of the contact surface of the sliding friction part or switching part is reduced and the wear resistance and lubricity are dramatically improved, and the timepiece can be used for a long time without regular disassembly, cleaning, and lubrication.

With respect to (2), the inventors discovered a method of improving the oil retention by coating the sliding friction parts or switching parts of a timepiece component with a composite plating containing carbon nanotubes in a metal plating, and thereby enabling using the timepiece for a long time without a drop in oil retention and without repeating the oil dispersion prevention process.

A timepiece component according to another aspect of the invention is a timepiece component that has a sliding friction part that slides in contact with another timepiece component, or a switching part that changes the contact state with another timepiece component in response to an operation operating the timepiece, wherein the contact surface of the sliding friction part or switching part is coated with a composite plating containing carbon nanotubes in a metal plating and is lubricated with oil.

By thus coating the contact surface of the sliding friction part or switching part of a timepiece component with a composite plating containing carbon nanotubes in a metal plating and lubricating the contact surface with oil, the oil retention of the sliding friction part or switching part is improved and the timepiece can be used for a long time without repeating the oil dispersion prevention process.

Preferably, the metal plating is nickel plating.

Nickel is a metal that is well-suited to electroplating, and this aspect of the invention therefore enables easily coating the timepiece component with a composite plating using an electroplating process. Coating the timepiece component with nickel also provides the metal of the timepiece component with corrosion protection.

Further preferably, the nickel plating is formed by an electroplating process.

This aspect of the invention can reduce the coefficient of friction and improve wear resistance and lubricity because the electroplating process can form a coating covering fine asperities on the contact surface of the sliding friction part or switching part.

Yet further preferably, the thickness of the nickel plating is greater than or equal to 2 μm and less than or equal to 20 μm.

If the thickness of the nickel plating is less than 2 μm, carbon nanotubes cannot be sufficiently mixed into the nickel plating and the composite plating can therefore not be formed on the timepiece component. On the other hand, if the thickness of the nickel plating is greater than 20 μm, variation in the film thickness of the nickel plating increases and the dimensional precision required for a timepiece component cannot be maintained. The thickness of the nickel plating is therefore preferably greater than or equal to 2 μm and less than or equal to 20 μm.

Yet further preferably, the length of the carbon nanotubes is greater than or equal to 10 μm and less than or equal to 20 μm.

A part of the carbon nanotubes near the surface of the metallic coating is embedded in the metal plate while the remaining portion is exposed at the surface of the metal plating forming the carbon nanotube layer. This carbon nanotube layer enables the composite plating to improve the wear resistance, lubricity, and oil retention of the contact surface of the sliding friction part or switching part.

The wear resistance, lubricity, and oil retention of the contact surface of the sliding friction part or switching part cannot be sufficiently improved if the length of the carbon nanotubes is shorter than 10 μm because a carbon nanotube layer cannot be sufficiently formed. In addition, the wear resistance, lubricity, and oil retention of the contact surface of the sliding friction part or switching part can be sufficiently improved if the carbon nanotubes are longer than 20 μm, but because the wear resistance, lubricity, and oil retention do not correspond to the length of the carbon nanotubes, this mixes carbon nanotubes uselessly with the nickel plate. The length of the carbon nanotubes is therefore preferably greater than or equal to 10 μm and less than or equal to 20 μm.

Further preferably, the composite plating is coated using a dispersant, and the carbon nanotubes are mixed unoriented in the metal plating.

A dispersant causes particles to disperse in the plating bath when mixing insoluble particles in an normal electroplating bath or chemical plating bath to form a composite plating, and an example of such a dispersant is polyacrylic acid.

By using a dispersant, this aspect of the invention can form an unoriented carbon nanotube layer exposed at the surface of the metal plating film, the contact surface of the sliding friction part or switching part can have a uniform coefficient of friction in all directions, can impede the flow of oil in all directions and can have a uniform oil retention characteristic.

Yet further preferably, the content of the carbon nanotubes to the metal plating is greater than or equal to 0.05 wt % and less than or equal to 1 wt %.

More specifically, if the carbon nanotube content to the metal plating is less than 0.05 wt %, the wear resistance, lubricity, and oil retention can be improved in the contact surface of the sliding friction part or switching part, but the coefficient of friction cannot be lowered to a level where the timepiece can be used for a long time without regular disassembly, cleaning, and lubrication or repeating the oil dispersion prevention process. Furthermore, if the carbon nanotube content to the metal plating is greater than 1 wt %, the dispersant content also increases, and plating defects including adhesion and cracking problems can occur. Reduction in the coefficient of friction also reaches the saturation level, and increasing the carbon nanotube content uselessly mixes more carbon nanotubes in the nickel plating. The content of the carbon nanotubes to the metal plating is therefore preferably greater than or equal to 0.05 wt % and less than or equal to 1 wt %.

Further preferably, the sliding friction part is a pinion and a pivot in a wheel train component for a timepiece.

The pinion and pivot in wheel train components for a timepiece are parts that rotate sliding against other timepiece components to move the hands, rotate sliding in one direction during normal timepiece operation, and are therefore timepiece components that are particularly susceptible to wear. The invention can therefore be advantageously used with such parts.

The switching part is preferably the setting lever and yoke of a setting mechanism.

The setting lever and yoke of the setting mechanism are parts of which the contact with other parts changes when the timepiece user adjusts the hands to set the time, and are timepiece components that are particularly susceptible to wear. The invention can therefore be advantageously used with such parts.

Another aspect of the invention is a timepiece having a timepiece component described above.

This aspect of the invention achieves the same effect and benefit as the timepiece component described above.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a schematic plan view of an electronically-controlled mechanical timepiece according to a first embodiment of the invention.

FIG. 2 is a section view showing a main part of FIG. 1.

FIG. 3 is a section view showing a main part of FIG. 1.

FIG. 4 is an enlarged view showing the part where the third wheel is supported by a jewel.

FIG. 5A is a schematic view showing the surface of the third pinion having a sliding friction part and the bottom pivot.

FIG. 5B is a schematic view showing the contact of the third pinion having a sliding friction part and the bottom pivot with the pivot hole.

FIG. 6 shows the results of a wear test of an electronickel carbon nanotube composite plating using alumina spheres at various carbon nanotube content levels.

FIG. 7 shows the results of a wear test of an electroless nickel plating using alumina spheres with and without lubrication.

FIG. 8 is an enlarged view of the part where the third wheel is supported by a jewel in a second embodiment of the invention.

FIG. 9 is an enlarged view of the surface of the third pinion coated by the composite plating and the bottom pivot in the second embodiment of the invention.

### DESCRIPTION OF PREFERRED EMBODIMENTS

### Embodiment 1

General Arrangement of an Electronically-Controlled Mechanical Timepiece

A first embodiment of the invention is described below with reference to the accompanying figures.

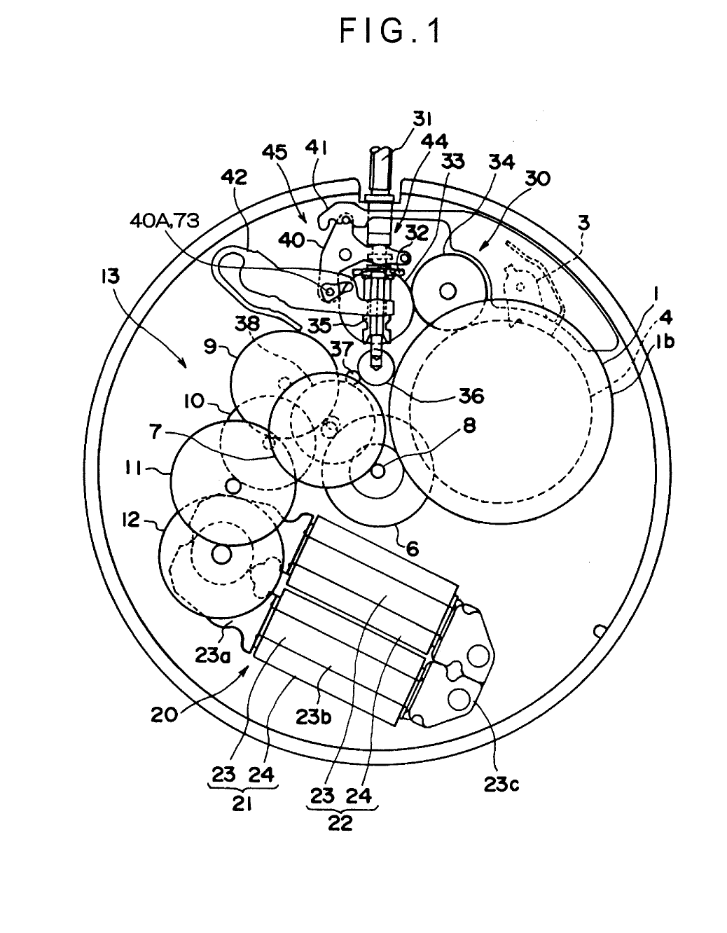

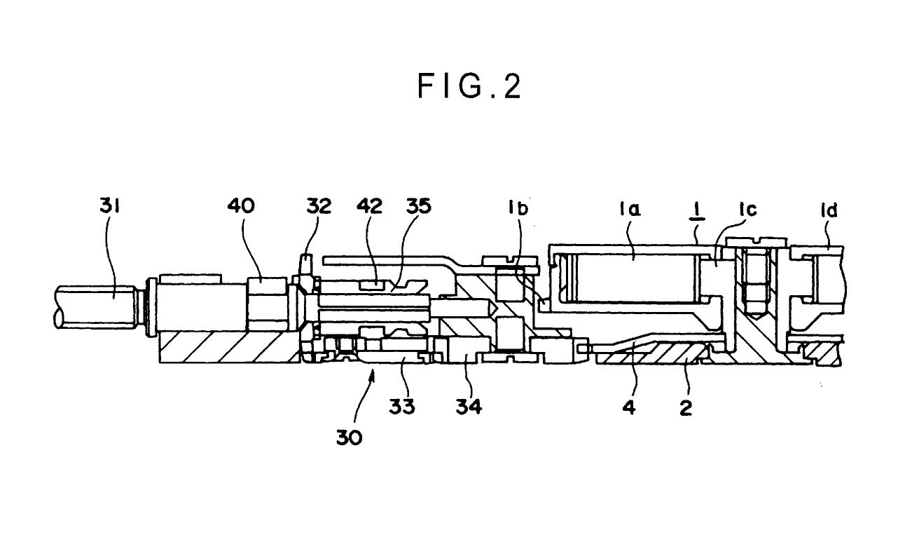

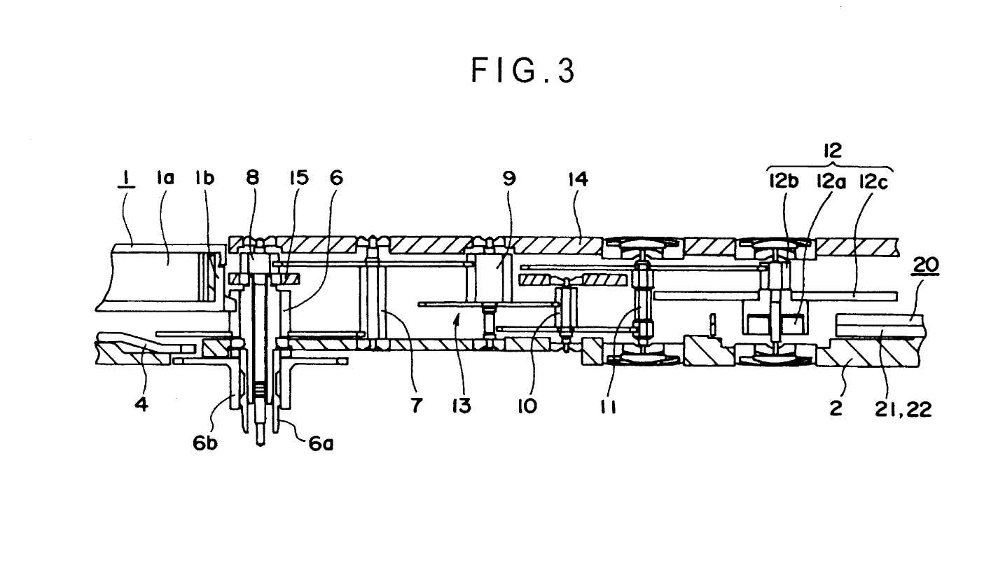

FIG. 1 is a schematic plan view of an electronically-controlled mechanical timepiece according to this embodiment of the invention, and FIG. 2 and FIG. 3 are section views showing a main part of FIG. 1.

As shown in FIG. 1 to FIG. 3, the electronically-controlled mechanical timepiece has a mainspring 1a, a barrel wheel 1b, a barrel arbor 1c, and a barrel cover 1d. The outside end of the mainspring 1a is fixed to the barrel wheel 1b and the inside end is fixed to the barrel arbor 1c. The barrel arbor 1c is supported on the main plate 2, and rotates in unison with the ratchet wheel 4.

The ratchet wheel 4 rotates clockwise and engages a detent 3 so that the ratchet wheel 4 does not rotate counterclockwise. The ratchet wheel 4 is arranged so that when a winding stem 31 connected to a crown not shown is operated, the ratchet wheel 4 is turned through an intervening winding pinion 32, crown wheel 33, and middle ratchet wheel 34, and turns the barrel arbor 1c to wind the mainspring 1a. The winding stem 31, the winding pinion 32, the crown wheel 33, the middle ratchet wheel 34, and the ratchet wheel 4 thus form a winding unit 30 that stores energy in the mainspring 1a.

As shown in FIG. 3, rotation of the barrel wheel 1b is transferred to the center wheel and pinion 6, accelerated and transferred to the third wheel 7, from the third wheel 7 to the seconds wheel 8 and the fourth wheel 9, and is then sequentially accelerated and transferred from the fourth wheel 9 to the fifth wheel 10, the sixth wheel 11, and to the rotor 12. The minute hand not shown is attached to the second wheel 6 through an intervening cannon pinion 6a. The hour wheel 6b is connected to the cannon pinion 6a through the day wheel 38, and the hour hand is fixed to the hour wheel 6b.

While described in further detail below, the wheels 6 to 11 and the rotor 12 are supported by the train wheel bridge 14, second bridge 15, and main plate 2. The wheels 6 to 11 render a wheel train 13 that transfers mechanical energy from the mainspring 1a to the hands (hour hand, minute hand, second hand).

As shown in FIG. 1, this electronically-controlled mechanical timepiece has a generator 20 composed of the rotor 12 and coil blocks 21 and 22. The generator 20 includes a rotor magnet 12a, a rotor pinion 12b, and a rotor balance wheel 12c. The rotor balance wheel 12c reduces variation in the rotor 12 speed due to variations in drive torque from the 1.

The coil blocks 21 and 22 each have a coil 24 wound onto a core 23. Each core 23 includes rendered in unison a core stator part 23a disposed adjacent tot he rotor 12, a core winding part 23b where the coil 24 is wound, and a core magnetic conduction part 23c. The core magnetic conduction parts 23c of the coil blocks 21 and 22 are connected together.

In this electronically-controlled mechanical timepiece AC output from the generator 20 is boosted and rectified by a rectification circuit such as a step-up rectification, a full-wave rectification, a half-wave rectification, or a transistor rectification circuit, and stored in a smoothing capacitor. Power from this capacitor operates a rotation control circuit not shown that controls rotation of the generator 20. The rotation control circuit is rendered as an integrated circuit (IC) including an oscillation circuit, a frequency divider, a rotation detection circuit, a speed comparison circuit, and an electromagnetic brake control means, and an crystal oscillator is used as the oscillation circuit.

The minute hand and the hour hand are set by pulling out the crown (not shown in the figure) and moving the winding stem 31 in the axial direction, moving the clutch wheel 35 to engage the setting wheel 36 by the action of the setting lever 40, the click spring 41, and the yoke 42, and then turning the cannon pinion 6a and the hour wheel 6b by means of the setting wheel 36 through the intervening intermediate day wheel 37 and the day wheel 38. The crown, the winding stem 31, the clutch wheel 35, the setting wheel 36, the intermediate day wheel 37, the day wheel 38, the setting lever 40, the click spring 41, and the yoke 42 thus render a setting mechanism 44.

Wheel Train 13 Support Structure

As shown in FIG. 3 the wheels 6 to 11 are supported to rotate freely between the train wheel bridge 14 and the main plate 2. More specifically, the top and bottom pivot parts of the wheels 6 to 11 are received by jewels fit into the train wheel bridge 14 and the main plate 2.

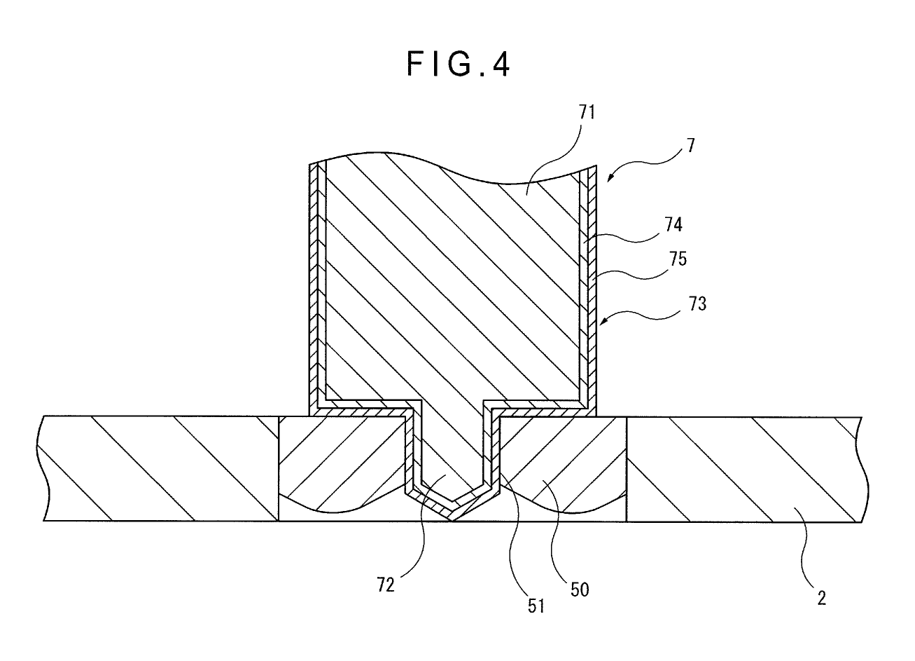

FIG. 4, for example, is an enlarged view of the part where the third wheel 7 is supported by a jewel 50.

As shown in FIG. 4 the third wheel 7 has a third pinion 71 that contacts the gear part of the seconds wheel 8 (FIG. 3), and a bottom pivot 72 disposed at the bottom of the third wheel 7. The third pinion 71 is made from carbon steel that is heat treated to a hardness of Hv 600 to 800. After heat treatment the bottom pivot 72 is finished to a mirror surface with a surface roughness of approximately Ra=5 nm.

The jewel 50 supports the third wheel 7 to rotate freely, and in this embodiment of the invention is a ruby with a pivot hole 51 in the center.

This embodiment of the invention describes the support structure of the third wheel 7 by way of example as a timepiece component having a sliding friction part.

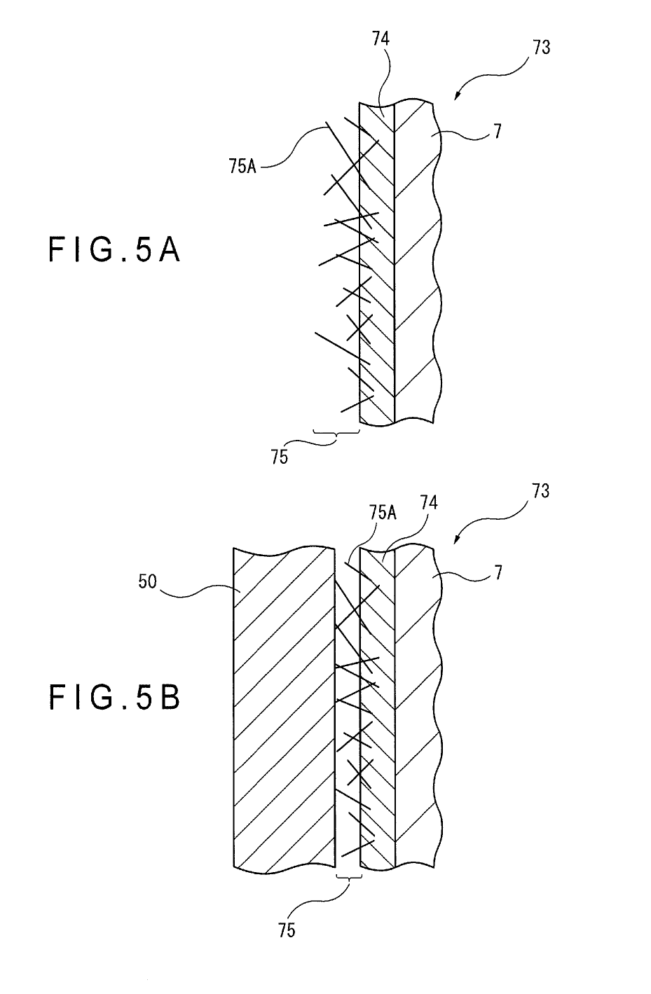

FIG. 5A is a schematic diagram showing the surface of the third pinion 71 and the bottom pivot 72 (FIG. 4), and FIG. 5B schematically shows the contact between the third pinion 71 and the bottom pivot 72 as sliding friction parts and the pivot hole 51.

The surface of the third pinion 71 and the bottom pivot 72, or more specifically the surface that contacts the pivot hole 51, is coated with a composite plating 73 as shown in FIG. 4, FIG. 5A, and FIG. 5B. This composite plating 73 includes a nickel plating 74 applied by an electroplating process, and an unoriented carbon nanotube layer 75 that is exposed at the surface of the nickel plating 74 using a dispersant such as polyacrylic acid.

The third pinion 71 and main plate 2 therefore slide against the pivot hole 51 on the intervening carbon nanotube layer 75 as shown in FIG. 5B.

The nickel plating 74 is coated to a film thickness of greater than or equal to 2 μm and less than or equal to 20 μm.

The carbon nanotube layer 75 is formed using carbon nanotubes 75A that are greater than or equal to 10 μm and less than or equal to 20 μm long. The content of the carbon nanotubes 75A to the nickel plating 74 is 0.5 wt %.

This composite plating 73 can be formed using the method taught in Japanese Unexamined Patent Appl. Pub. JP-A-2006-28636, for example.

The setting lever 40 and the yoke 42 in the setting mechanism 44 (FIG. 1) described above are described by way of example as a timepiece component having a switching part.

More specifically, the contact surface 40A of the setting lever 40 to the yoke 42 is coated with the composite plating 73 described above as shown in FIG. 1. The contact state of the the contact surface 40A of the setting lever 40 to the yoke 42 changes as a result of setting the hands.

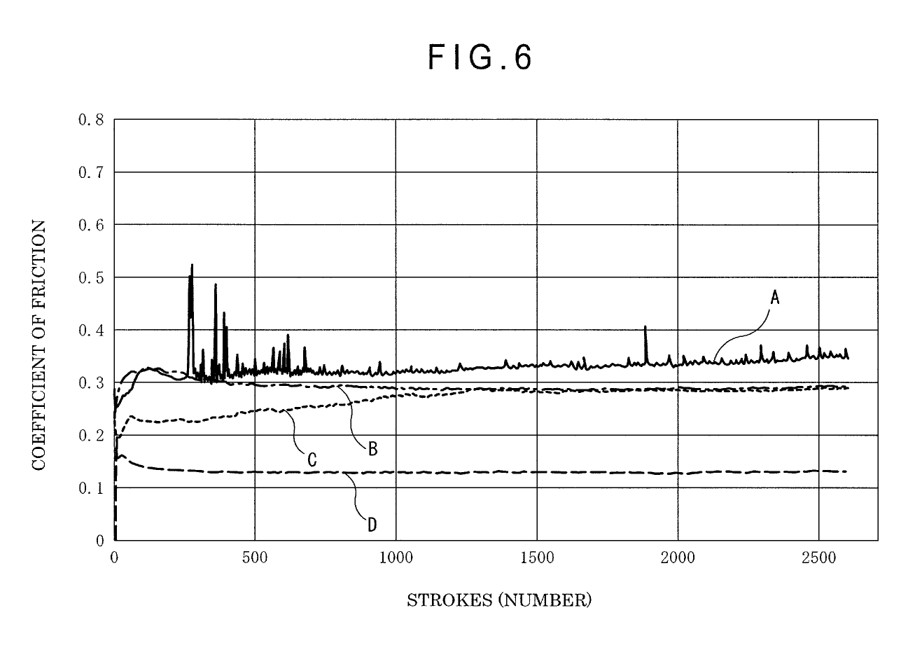

FIG. 6 shows the results of a wear test of an electronickel carbon nanotube composite plating using alumina spheres at various carbon nanotube content levels.

This test was conducted using a reciprocating pivoted ball-on-plate friction and wear tester. The test samples had a 20 μm thick composite plating containing carbon nanotubes formed by an electroplating process on a substrate (high carbon steel, hardness Hv=700, surface roughness Ra=5 nm). The length of the carbon nanotubes mixed in this composite plating was greater than or equal to 10 μm and less than or equal to 20 μm long. Alumina spheres (Al2O3) (diameter of 4.762 mm, surface roughness Ra=5 nm, hardness Hv=1500) were used as the abrasive agent.

The test conditions were a load of 200 g (30 kg/mm2), a stroke of 2 Hz (0.5 Hz/stroke), a stroke length of 10 mm, and total test time of 1400 seconds. These test conditions are equivalent to a two month durability test when converted to the sliding between the bottom pivot 72 of the third pinion 71 and the jewel 50 of a timepiece component.

FIG. 6 shows the coefficient of friction on the y-axis and the number of strokes on the x-axis. The content of the carbon nanotubes 75A to the nickel plating 74 was 0 wt %, 0.05 wt %, 0.1 wt %, and 0.5 wt % as shown by curve A, curve B, curve C, and curve D, respectively. The contact surface was not lubricated.

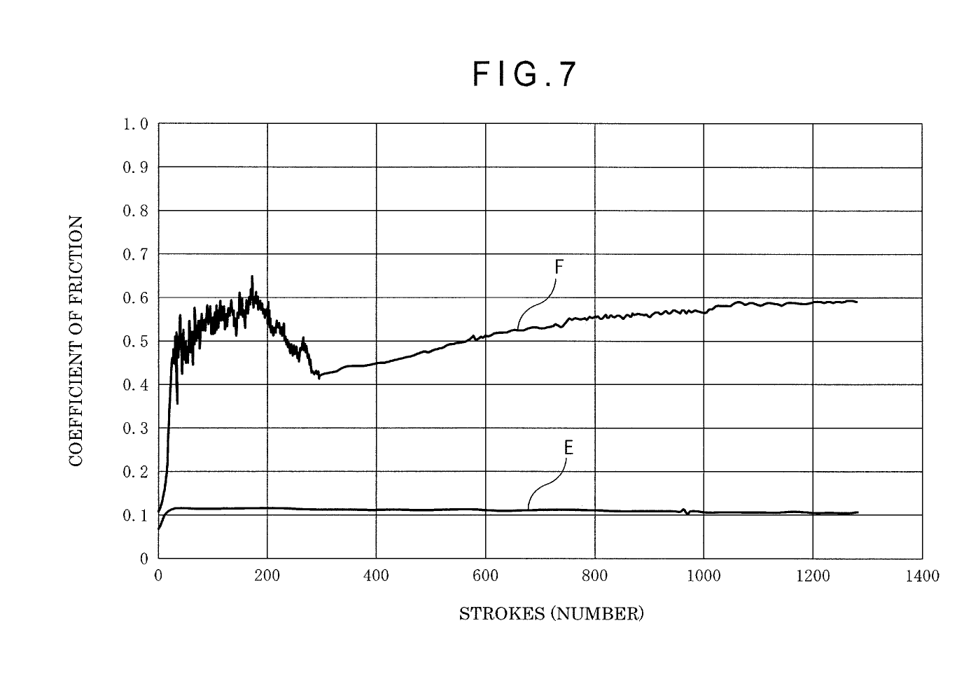

Because the metal substrate was polished and the nickel plate was imparted by an electroplating process in this embodiment, the coefficient of friction when the carbon nanotube 75A content was 0 wt % as shown by curve A, that is, when a nickel plating and not a composite plating was formed, was lower than when the nickel plating was formed by an electroless process as indicated by curve F in FIG. 7. However, at some point between 0 to 500 strokes there is a sharp rise in the coefficient of friction to approximately 0.5.

As shown by curves B, C, and D, however, there is no sudden rise in the coefficient of friction at a carbon nanotube 75A content of 0.05 wt %, 0.1 wt %, or 0.5 wt %. The coefficient of friction also decreases as the carbon nanotube 75A content increases, and when the carbon nanotube 75A content reaches 0.5 wt %, the coefficient of friction is stable at approximately 0.1, the same coefficient of friction achieved when the nickel plating was formed by an electroless process and the contact surface was lubricated as indicated by curve E in FIG. 7.

Because the coefficient of friction on the side of the carbon nanotubes 75A is substantially 0.1, further increasing the carbon nanotube 75A content will not greatly reduce the coefficient of friction, and the coefficient of friction when the carbon nanotube 75A content is 1 wt % is substantially the same as when the carbon nanotube 75A content is 0.5 wt %. The carbon nanotube 75A content is therefore preferably less than or equal to 1 wt % so that carbon nanotubes 75A are not needlessly mixed with the nickel plating 74.

Effect

The electronically-controlled mechanical timepiece according to this embodiment of the invention has the following effect.

(1) By coating the contact surfaces of the third pinion 71 and bottom pivot 72 with a composite plating 73, the coefficient of friction can be reduced and the wear resistance and lubricity can be dramatically improved, and the electronically-controlled mechanical timepiece can be used for a long time without regular disassembly, cleaning, and lubrication. This is because the sides of many carbon nanotubes 75A slide against the inside circumference surface of the pivot hole 51 with many points of contact, and the surface of the nickel plating 74 on the third pinion 71 and the bottom pivot 72 does not rub directly against the inside circumference surface of the pivot hole 51. The sides of the carbon nanotubes 75A slide with many points of contact because the ends of the carbon nanotubes are brushed and elastically deformed in the direction of the sliding action. Furthermore, because the mechanical strength of the carbon nanotubes is greater than metal, the carbon nanotubes are difficult to crush. The electronically-controlled mechanical timepiece can therefore be used for a long time.

(2) Because nickel plating 74 is selected as the metal plating part of the composite plating 73, the timepiece components can be easily coated with the composite plating 73 by an electroplating process. The metal of the timepiece component can also be prevented from rusting by the nickel coating.

(3) Large quantities of timepiece components can be coated with the composite plating because the nickel plating 74 is formed by an electroplating process. Furthermore, because electroplating also covers fine asperities on the contact surfaces of the third pinion 71 and bottom pivot 72, the coefficient of friction can be reduced and wear resistance and lubricity can be improved.

(4) Carbon nanotubes 75A can be sufficiently mixed with the nickel plating 74 and the dimensional precision required for timepiece components can be maintained because the thickness of the nickel plating 74 is greater than or equal to 2 μm and less than or equal to 20 μm.

(5) A sufficient carbon nanotube layer 75 can be formed without including needless carbon nanotubes 75A in the nickel plating 74 because the length of the carbon nanotubes 75A is greater than or equal to 10 μm and less than or equal to 20 μm.

(6) The contact surfaces of the third pinion 71 and bottom pivot 72 can have a uniform coefficient of friction in all directions because an unoriented carbon nanotube layer 75 is formed exposed at the surface of the nickel plating 74 by using a dispersant.

(7) The coefficient of friction can be reduced to a level enabling long-time use of the electronically-controlled mechanical timepiece without regular disassembly, cleaning, and lubrication, and more carbon nanotubes 75A than are needed are not contained in the nickel plating 74 because the content of the carbon nanotubes 75A to the nickel plating 74 is 0.5 wt %.

(8) The electronically-controlled mechanical timepiece can be used for a long time without regular disassembly, cleaning, and lubrication because the electronically-controlled mechanical timepiece has a third pinion 71 and bottom pivot 72 that have the contact surface coated with a composite plating 73.

### Embodiment 2

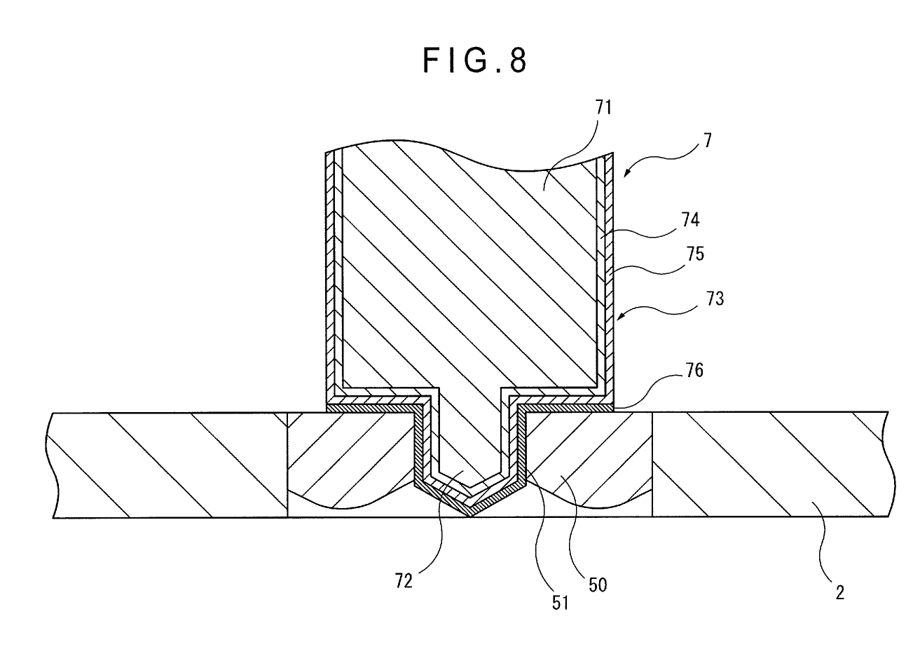

A second embodiment of the invention is described next. As shown in FIG. 8 this embodiment of the invention lubricates between the third pinion 71 and bottom pivot 72 and the pivot hole 51 with a special horological oil 76. Except for this use of lubrication, the arrangement of a timepiece according to this embodiment of the invention is the same as the timepiece according to the first embodiment.

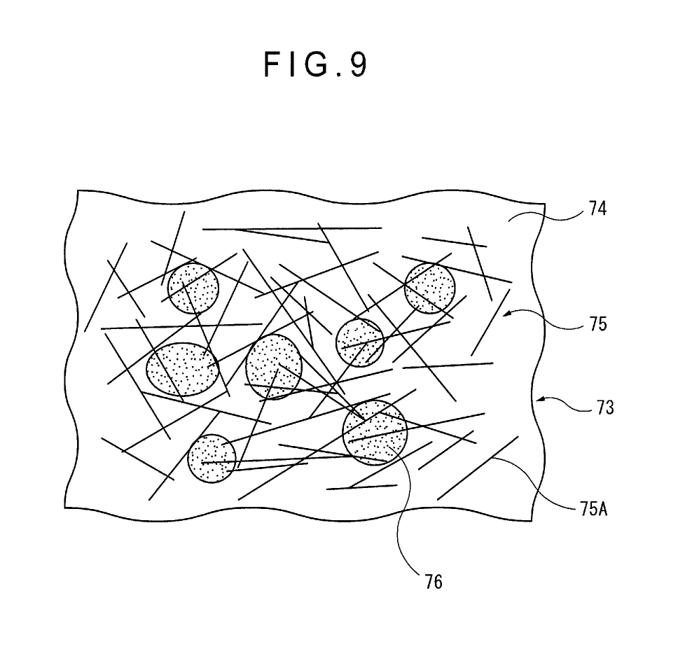

FIG. 9 is an enlarged view of the surface of the third pinion 71 and bottom pivot 72 coated with a composite plating 73.

As shown in FIG. 9 the horological oil 76 is held by the carbon nanotubes 75A in the carbon nanotube layer 75. Because the carbon nanotube layer 75 is unoriented, the oil is impeded from flowing in any direction and the oil is retained uniformly.

As in the first embodiment, the surfaces of the third pinion 71 and the bottom pivot 72, or more specifically the surfaces that contact the pivot hole 51, are coated with a composite plating 73 (FIG. 4) in this embodiment of the invention. This embodiment of the invention can reduce the coefficient of friction even lower than in the first embodiment as a result of lubricating with the horological oil 76 in addition to coating with this composite plating 73.

More specifically, as shown by the test results shown in FIG. 7, the coefficient of friction (curve E) when lubrication was used was significantly lower than when lubrication was not used (curve F), and when combined with the test results shown in FIG. 6 it will be apparent that the coefficient of friction can be dramatically reduced by using lubrication in conjunction with a composite plating containing carbon nanotubes. As will be known from FIG. 6 the carbon nanotube content is preferably in the range of 0.05 wt % to 1 wt %. More specifically, the coefficient of friction can be dramatically reduced by lubricating and controlling the carbon nanotube content to the metal plating to greater than or equal to 0.05 wt % and less than or equal to 1 wt %.

In addition to the benefits afforded by the first embodiment described above, the electronically-controlled mechanical timepiece according to this embodiment of the invention has the following effects.

(9) Because the contact surfaces of the third pinion 71 and the bottom pivot 72 are coated with a composite plating 73 and are lubricated with horological oil 76, oil retention can be improved and the electronically-controlled mechanical timepiece can be used for a long time without repeating the oil dispersion prevention process.

(10) The contact surfaces of the third pinion 71 and the bottom pivot 72 can impede the flow of oil in all directions and be imparted with uniform oil retention as a result of forming an unoriented carbon nanotube layer 75 on the surface of the nickel plating 74 by using a dispersant.

(11) Oil retention sufficient to hold the horological oil can be imparted and carbon nanotubes 75A are not uselessly contained in the nickel plating 74 because the content of the carbon nanotubes 75A to the nickel plating 74 is 0.5 wt %.

(12) The electronically-controlled mechanical timepiece can be used for a long time without repeating the oil dispersion prevention process because the electronically-controlled mechanical timepiece has a third pinion 71 and bottom pivot 72 that have the contact surface coated with a composite plating 73.

Other Variations

The invention is not limited to the embodiments described above, and modifications and improvements that achieve the same object are included in the invention.

For example, the support structure of the third wheel 7 is used as an example of a timepiece component that has a sliding friction part, and the contact surfaces of the third pinion 71 and the bottom pivot 72 are coated with a composite plating 73, but the timepiece component that has a sliding friction part could be the support structure for any other wheel. More particularly, the composite plating can be imparted to any timepiece component that has a sliding friction part.

The setting lever 40 and the yoke 42 of the setting mechanism 44 are used by way of example as timepiece components having a switching part in the above embodiments, and the contact surface 40A of the setting lever 40 to the yoke 42 is coated with the composite plating 73, but the timepiece component having a switching part can be another component of the setting mechanism. More particularly, the composite plating can be imparted to any timepiece component having a switching part.

Furthermore, these embodiments use a nickel plating 74 as the metal plating, but a different metal plating can be selected. Further alternatively, an alloy plating may be selected.

The composite plating 73 is applied to the contact surface of the sliding friction part by an electroplating process in the foregoing embodiments, but can be coated using an electroless plating process.

The thickness of the nickel plating 74 is greater than or equal to 2 μm and less than or equal to 20 μm in the above embodiments, but the thickness can differ. More specifically, it is only necessary to coat the contact surface of the sliding friction part or the switching part with the composite plating. To further improve dimensional precision, a thick coating can be formed and then polished to the desired thickness.

The length of the carbon nanotubes 75A in the foregoing embodiments is greater than or equal to 10 μm and less than or equal to 20 μm, but a different length can be used. More particularly, any length that enables forming the composite plating on the contact surface of the sliding friction part or switching part can be used.

An unoriented carbon nanotube layer 75 is formed exposed at the surface of the nickel plating 74 by using a dispersant in the above embodiments, but an oriented carbon nanotube layer can be formed instead. More specifically, it is sufficient to form a carbon nanotube layer.

The content of the carbon nanotubes 75A to the nickel plating 74 is 0.5 wt % in the above embodiments, but the content is not so limited insofar as the composite plating can be formed on the contact surface of the sliding friction part or switching part.

The contact surfaces of the third pinion 71 and the bottom pivot 72 are coated with the composite plating 73 in the above embodiments, but the composite plating 73 can also be formed on the contact surface of the pivot hole 51. Further alternatively, both the contact surfaces of the third pinion 71 and bottom pivot 72 and the contact surface of the pivot hole 51 can be coated with the composite plating 73 to further dramatically improve the wear resistance, lubricity, and oil retention of the sliding friction parts and switching parts compared with forming the composite plating on the contact surface of only one timepiece component.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

The entire disclosure of Japanese Patent Application Nos: 2006-320656, filed Nov. 28, 2006, 2006-320655, filed Nov. 28, 2006, 2007-186785, filed Jul. 18, 2007, and 2007-186784, filed Jul. 18, 2007 are expressly incorporated by reference herein.

What is claimed is:

1. A timepiece component comprising a sliding friction part that slides in contact with another timepiece component, or a switching part that changes the contact state with another timepiece component in response to an operation operating the timepiece, wherein:
the contact surface of the sliding friction part or switching part is coated with a composite plating containing carbon nanotubes in a metal plating.

2. The timepiece component described in claim 1, wherein the contact surface of the sliding friction part or the switching part is lubricated with oil.

3. The timepiece component described in claim 1, wherein the metal plating is nickel plating.

4. The timepiece component described in claim 3, wherein the nickel plating is formed by an electroplating process.

5. The timepiece component described in claim 4, wherein the thickness of the nickel plating is greater than or equal to 2 μm and less than or equal to 20 μm.

6. The timepiece component described in claim 1, wherein the length of the carbon nanotubes is greater than or equal to 10 μm and less than or equal to 20 μm.

7. The timepiece component described in claim 1, wherein:
the composite plating is coated using a dispersant; and
the carbon nanotubes are mixed unoriented in the metal plating.

8. The timepiece component described in claim 1, wherein the content of the carbon nanotubes to the metal plating is greater than or equal to 0.05 wt % and less than or equal to 1 wt %.

9. The timepiece component described in claim 1, wherein the sliding friction part is a pinion and a pivot in a wheel train component for a timepiece.

10. The timepiece component described in claim 1, wherein the switching part is the setting lever and yoke of a setting mechanism.

11. A timepiece comprising the timepiece component described in claim 1.
